(19) United States
(12) Patent Application Publication
(10) Pub. No.: US 2014/0064147 A1
(43) Pub. Date: Mar. 6, 2014

(54) METHODS AND APPARATUS FOR WAN ENABLED PEER DISCOVERY

(71) Applicants: Hua Wang, Bridgewater, NJ (US); Junyi Li, Chester, NJ (US); Shailesh Patil, Bridgewater, NJ (US); Saurabh R. Tavildar, Jersey City, NJ (US)

(72) Inventors: Hua Wang, Bridgewater, NJ (US); Junyi Li, Chester, NJ (US); Shailesh Patil, Bridgewater, NJ (US); Saurabh R. Tavildar, Jersey City, NJ (US)

(73) Assignee: QUALCOMM Incorporated, San Diego, CA (US)

(21) Appl. No.: 13/598,344

(22) Filed: Aug. 29, 2012

(51) Int. Cl. H04W 72/04; H04W 24/00

(52) U.S. Cl. 370/255

(57) ABSTRACT

A method, an apparatus, and a computer program product for communication are provided in connection with WAN entity enabled discovery to for P2P communications. In one example, a WAN entity is equipped to obtain location information associated with a UE, allocate a peer discovery resource to the UE for use during peer discovery based at least in part on the obtained location information, and send a control message to the UE including the allocated peer discovery resource and one or more attributes associated with the peer discovery resource for use during peer discovery. In another example, a UE is equipped to send location information associated with a physical location of the UE to a WAN entity, receive a control message including a peer discovery resource and one or more attributes associated with the peer discovery resource, and use the peer discovery resource during peer discovery.

### BACKGROUND

1. Field

The present disclosure relates generally to communication systems, and more particularly, to wide area network (WAN) entity enabled peer discovery to facilitate efficient peer-to-peer (P2P) communications.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

For many applications (e.g., social networking applications) it is important for a device to discover other devices within the vicinity. A device may broadcast a peer discovery signal which conveys an “expression” that can identify itself. The device may also need to detect other devices' peer discovery signal. Ideally, each peer device may use a different time and/or frequency resource to broadcast its peer discovery signal to avoid interference with other peer device's peer discovery signal. Currently, in operation, since there are a finite number of available time/frequency resources, some peer devices use the same time and frequency resource to broadcast their respective peer discovery signals. As such, peer devices should choose their peer discovery resource in an efficient spacial reuse manner so that their peer discovery signal can be correctly received by many other peer devices.

One distributed peer discovery scheme allows each peer device to detect received energy values in a set of pre-defined time/frequency resources used for peer discovery, and then pick a time/frequency resource with a small detected energy to broadcast its peer discovery signal. However, due to measurement errors of the received energy of peer discovery signal, this distributed peer discovery scheme cannot guarantee that two peer devices in the discover radius of each other choose different time/frequency resources to broadcast their peer discovery signal. Hence collision of peer discovery resource may occur. Another drawback of this distributed peer discovery scheme is that each device chooses their peer discovery resource only based on their local information. Another drawback of this distributed peer discovery scheme is that peer discovery resource selection by other devices may result in desensing issues when those resources are attempting to be desensed.

Additionally, when the number of devices engaging in discovery is large, then the number of resources used for discovery may also be large and a peer device may have to wake-up for a longer period of time. These longer durations may lead to large power consumption.

Accordingly, a system and method to assist in facilitating efficient WAN entity enabled peer discovery is desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with WAN entity enabled discovery to for P2P communications. In one example, a WAN entity is equipped to obtain location information associated with a UE, allocate a peer discovery resource to the UE for use during peer discovery based at least in part on the obtained location information, and send a control message to the UE including the allocated peer discovery resource and one or more attributes associated with the peer discovery resource for use during peer discovery. In another example, a UE is equipped to send location information associated with a physical location of the UE to a WAN entity, receive a control message including a peer discovery resource and one or more attributes associated with the peer discovery resource, and use the peer discovery resource during peer discovery.

According to related aspects, a method for WAN entity enabled P2P discovery is provided. The method can include obtaining, by a WAN entity, location information associated with a UE. Further, the method can include allocating a peer discovery resource to the UE for use during peer discovery based at least in part on the obtained location information. Moreover, the method may include sending a control message to the UE including the allocated peer discovery resource and one or more attributes associated with the peer discovery resource for use during peer discovery.

Another aspect relates to a communications apparatus for WAN entity enabled P2P discovery. The communications apparatus can include means for obtaining, by a WAN entity, location information associated with a UE. Further, the communications apparatus can include means for allocating a peer discovery resource to the UE for use during peer discovery based at least in part on the obtained location information. Moreover, the communications apparatus can include means for sending a control message to the UE including the allocated peer discovery resource and one or more attributes associated with the peer discovery resource for use during peer discovery.

Another aspect relates to a communications apparatus. The apparatus can include a processing system configured to obtain location information associated with a UE. Further, the processing system may be configured to allocate a peer discovery resource to the UE for use during peer discovery based at least in part on the obtained location information. Moreover, the processing system may further be configured to send a control message to the UE including the allocated peer discovery resource and one or more attributes associated with the peer discovery resource for use during peer discovery.

Still another aspect relates to a computer program product, which can have a computer-readable medium including code for obtaining, by a WAN entity, location information associated with a UE. Further, the computer-readable medium can include code for allocating a peer discovery resource to the UE for use during peer discovery based at least in part on the obtained location information. Moreover, the computer-readable medium can include code for sending a control message to the UE including the allocated peer discovery resource and one or more attributes associated with the peer discovery resource for use during peer discovery.

According to related aspects, a method for WAN entity enabled P2P discovery is provided. The method can include sending, by a UE, location information associated with a physical location of the UE to a WAN entity. Further, the method can include receiving a control message including a peer discovery resource and one or more attributes associated with the peer discovery resource. In an aspect, the peer discovery resource may be allocated by the WAN entity based at least in part on the location information. Moreover, the method may include using the peer discovery resource during peer discovery.

Another aspect relates to a wireless communications apparatus enabled for WAN entity enabled P2P discovery. The wireless communications apparatus can include means for sending, by a UE, location information associated with a physical location of the UE to a WAN entity. Further, the wireless communications apparatus can include means for receiving a control message including a peer discovery resource and one or more attributes associated with the peer discovery resource. In an aspect, the peer discovery resource may be allocated by the WAN entity based at least in part on the location information. Moreover, the wireless communications apparatus can include means for using the peer discovery resource during peer discovery.

Another aspect relates to a wireless communications apparatus. The apparatus can include a processing system configured to send, by a UE, location information associated with a physical location of the UE to a WAN entity. Further, the processing system may be configured to receive a control message including a peer discovery resource and one or more attributes associated with the peer discovery resource. In an aspect, the peer discovery resource may be allocated by the WAN entity based at least in part on the location information. Moreover, the processing system may further be configured to use the peer discovery resource during peer discovery.

Still another aspect relates to a computer program product, which can have a computer-readable medium including code for sending, by a UE, location information associated with a physical location of the UE to a WAN entity. Further, the computer-readable medium can include code for receiving a control message including a peer discovery resource and one or more attributes associated with the peer discovery resource. In an aspect, the peer discovery resource may be allocated by the WAN entity based at least in part on the location information. Moreover, the computer-readable medium can include code for using the peer discovery resource during peer discovery.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a network architecture.

FIG. 2 is a diagram of a wireless peer-to-peer communications system.

FIG. 3 is a diagram illustrating an exemplary time structure for peer-to-peer communication between the wireless devices.

FIG. 4 is a diagram illustrating the channels in each frame of superframes in one grandframe.

FIG. 5 is a diagram illustrating an operation timeline of a miscellaneous channel and a structure of a peer discovery channel.

FIG. 6 is a diagram illustrating an example of WAN entity and user equipment in an access network.

FIG. 7 is a diagram of a wireless WAN communications system operable to support peer-to-peer communications according to an aspect.

FIG. 8 is a flow chart of a method of wireless communication.

FIG. 9 is a conceptual data flow diagram illustrating the data flow between different modules/means/components in an exemplary apparatus.

FIG. 10 is a diagram illustrating an example of a hardware implementation for an apparatus employing a processing system.

FIG. 11 is a flow chart of another method of wireless communication.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

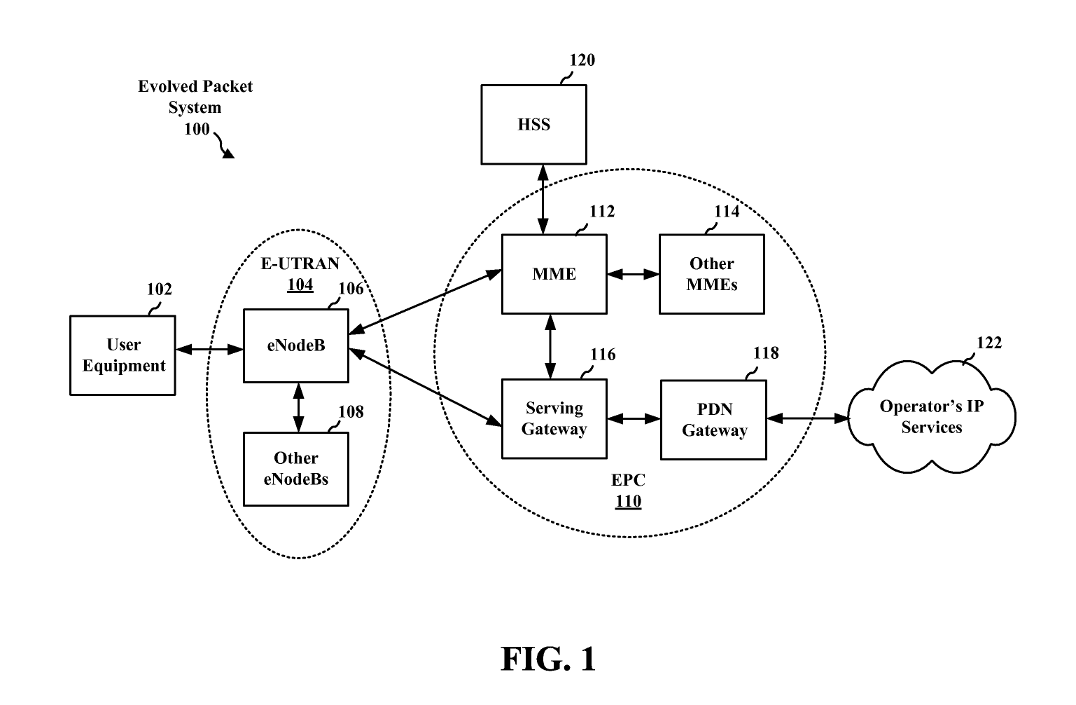

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

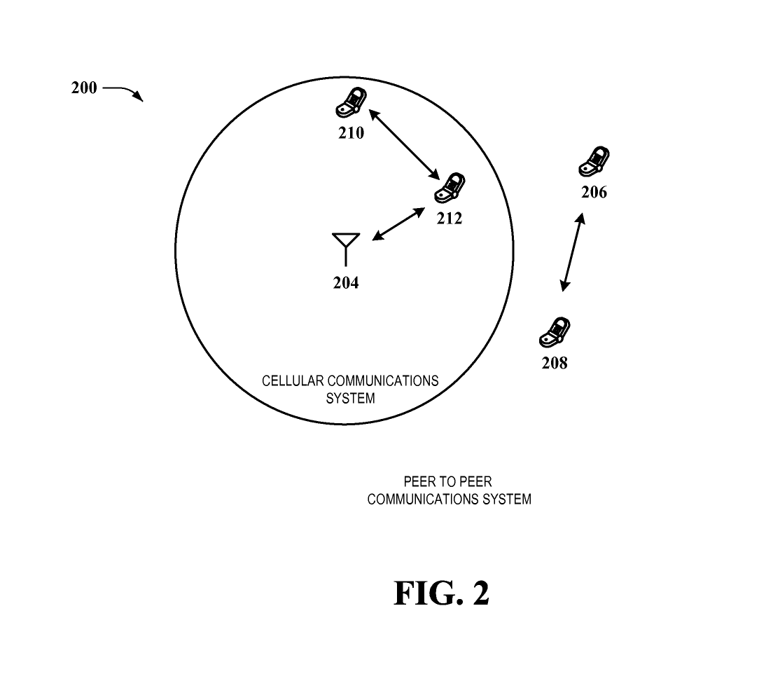

FIG. 2 is a drawing of an exemplary peer-to-peer communications system 200. The peer-to-peer communications system 200 includes a plurality of wireless devices 206, 208, 210, 212. The peer-to-peer communications system 200 may overlap with a cellular communications system, such as for example, a wireless wide area network (WWAN). Some of the wireless devices 206, 208, 210, 212 may communicate together in peer-to-peer communication, some may communicate with the base station 204, and some may do both. For example, as shown in FIG. 2, the wireless devices 206, 208 are in peer-to-peer communication and the wireless devices 210, 212 are in peer-to-peer communication. The wireless device 212 is also communicating with the base station 204.

The wireless device may alternatively be referred to by those skilled in the art as user equipment (UE), a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. To simplify the discussion, the exemplary methods and apparatus are discussed within the context of FlashLinQ. However, one of ordinary skill in the art would understand that the exemplary methods and apparatuses are applicable more generally to a variety of other wireless peer-to-peer communication systems.

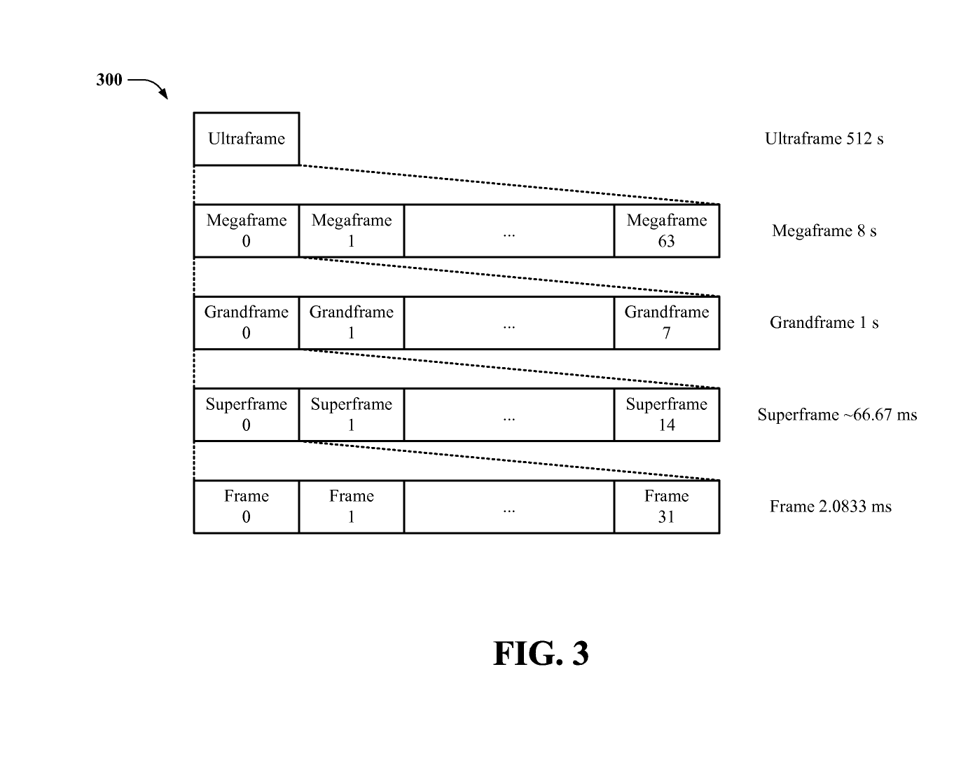

FIG. 3 is a diagram 300 illustrating an exemplary time structure for peer-to-peer communication between the wireless devices 100. An ultraframe is 512 seconds and includes 64 megaframes. Each megaframe is 8 seconds and includes 8 grandframes. Each grandframe is 1 second and includes 15 superframes. Each superframe is approximately 66.67 ms and includes 32 frames. Each frame is 2.0833 ms.

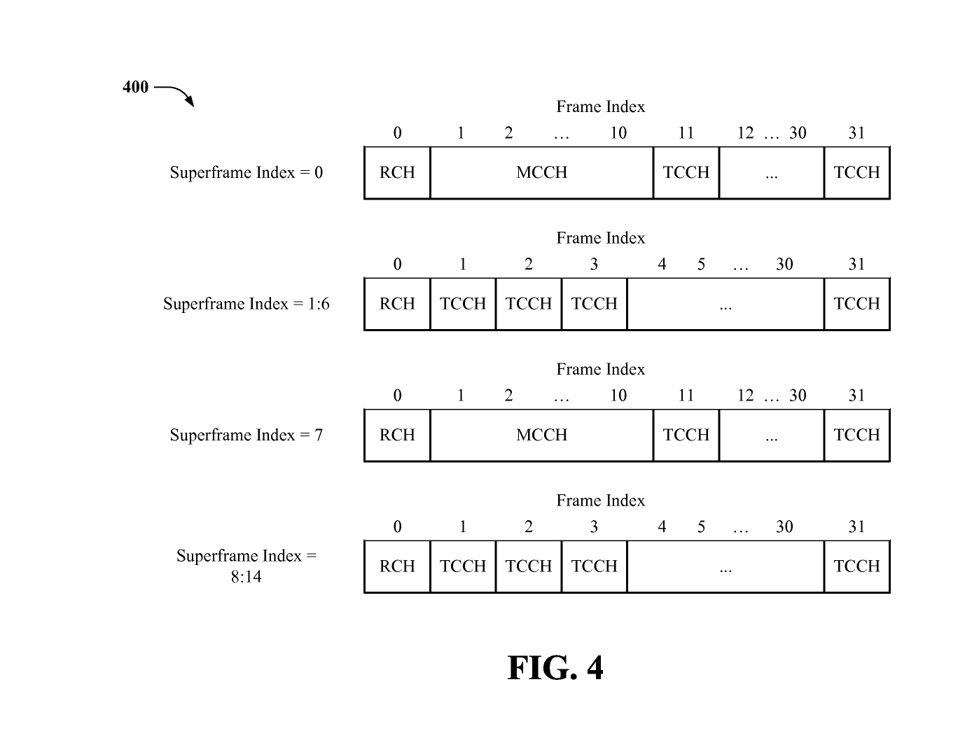

FIG. 4 is a diagram 400 illustrating the channels in each frame of superframes in one grandframe. In a first superframe (with index 0), frame 0 is a reserved channel (RCH), frames 1-10 are each a miscellaneous channel (MCCH), and frames 11-31 are each a traffic channel (TCCH). In the 2^{nd} through 7^{th} superframes (with index 1:6), frame 0 is a RCH and frames 1-31 are each a TCCH. In an 8^{th} superframe (with index 7), frame 0 is a RCH, frames 1-10 are each a MCCH, and frames 11-31 are each a TCCH. In the 9^{th} through 15^{th} superframes (with index 8:14), frame 0 is a RCH and frames 1-31 are each a TCCH. The MCCH of superframe index 0 includes a secondary timing synchronization channel, a peer discovery channel, a peer page channel, and a reserved slot. The MCCH of superframe index 7 includes a peer page channel and reserved slots. The TCCH includes connection scheduling, a pilot, channel quality indicator (CQI) feedback, a data segment, and an acknowledgement (ACK).

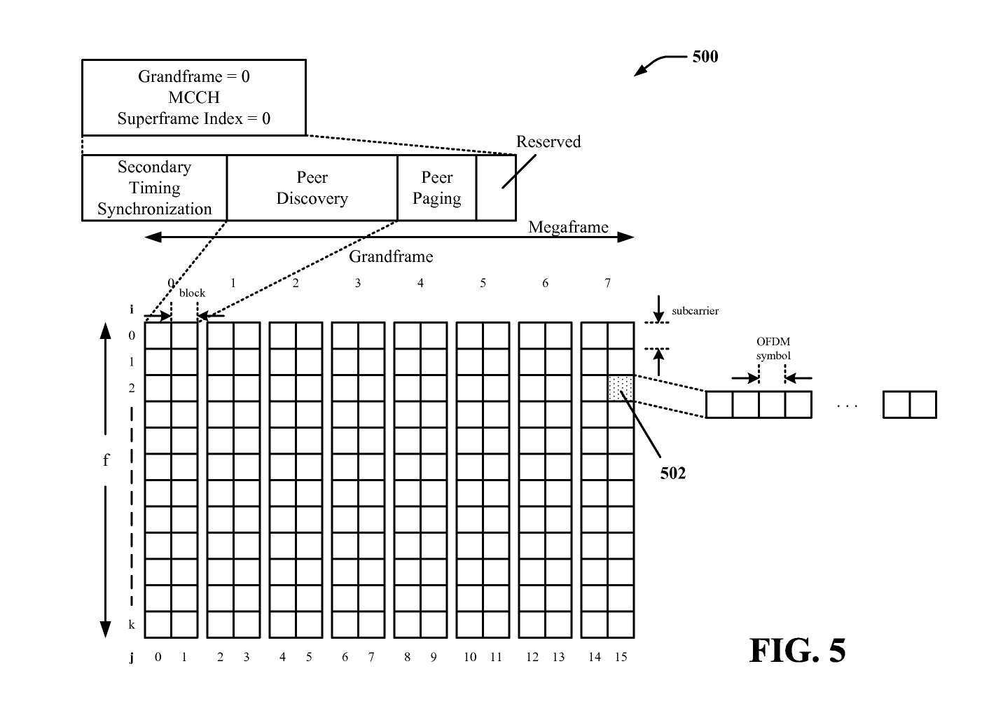

FIG. 5 is a diagram 500 illustrating an operation timeline of the MCCH and an exemplary structure of a peer discovery channel. As discussed in relation to FIG. 4, the MCCH of superframe index 0 includes a secondary timing synchronization channel, a peer discovery channel, a peer paging channel, and a reserved slot. The peer discovery channel may be divided into subchannels. For example, the peer discovery channel may be divided into a long range peer discovery channel, a medium range peer discovery channel, a short range peer discovery channel, and other channels. Each of the subchannels may include a plurality of blocks/resources for communicating peer discovery information. Each block may include a plurality of orthogonal frequency-division multiplexing (OFDM) symbols (e.g., 72) at the same subcarrier. FIG. 5 provides an example of a subchannel (e.g., short range peer discovery channel) including blocks in one megaframe, which includes the MCCH superframe index 0 of grandframes 0 through 7. Different sets of blocks correspond to different peer discovery resource identifiers (PDRIDs). For example, one PDRID may correspond to one of the blocks in the MCCH superframe index 0 of one grandframe in the megaframe.

Upon power up, a wireless device listens to the peer discovery channel for a period of time (e.g., two megaframes) and selects a PDRID based on a determined energy on each of the PDRIDs. For example, a wireless device may select a PDRID corresponding to block 502 (i=2 and j=15) in a first megaframe of an ultraframe. The particular PDRID may map to other blocks in other megaframes of the ultraframe due to hopping. In blocks associated with the selected PDRID, the wireless device transmits its peer discovery signal. In blocks unassociated with the selected PDRID, the wireless device listens for peer discovery signals transmitted by other wireless devices.

The wireless device may also reselect a PDRID if the wireless device detects a PDRID collision. That is, a wireless device may listen rather than transmit on its available peer discovery resource in order to detect an energy on the peer discovery resource corresponding to its PDRID. The wireless device may also detect energies on other peer discovery resources corresponding to other PDRIDs. The wireless device may reselect a PDRID based on the determined energy on the peer discovery resource corresponding its PDRID and the detected energies on the other peer discovery resources corresponding to other PDRIDs.

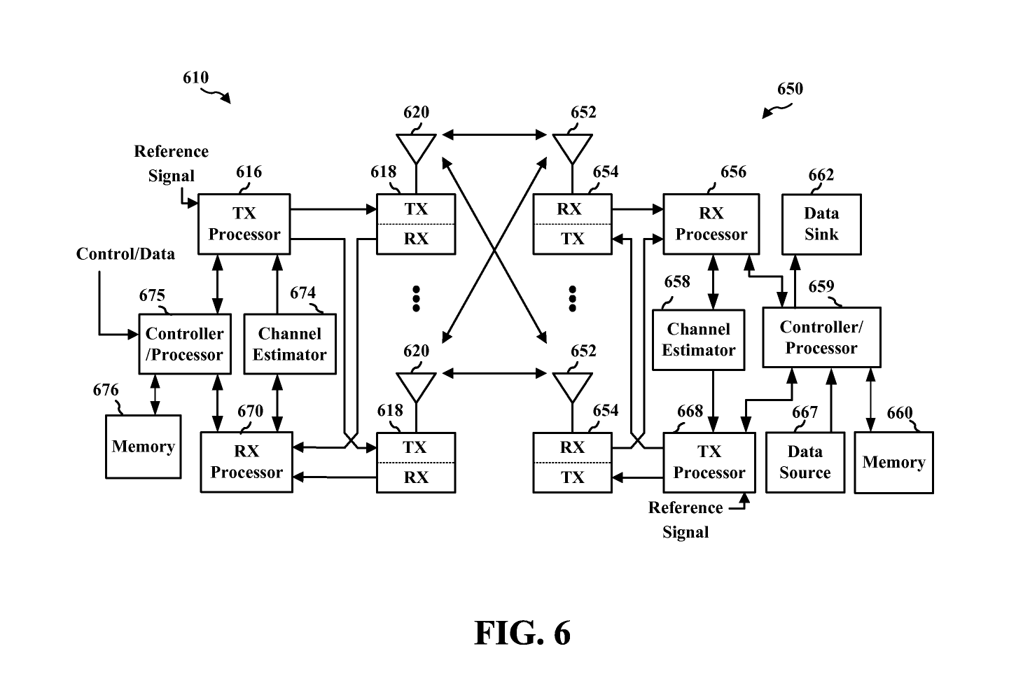

FIG. 6 is a block diagram of a WAN entity (e.g., eNB, MME, etc.) 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the WAN entity 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

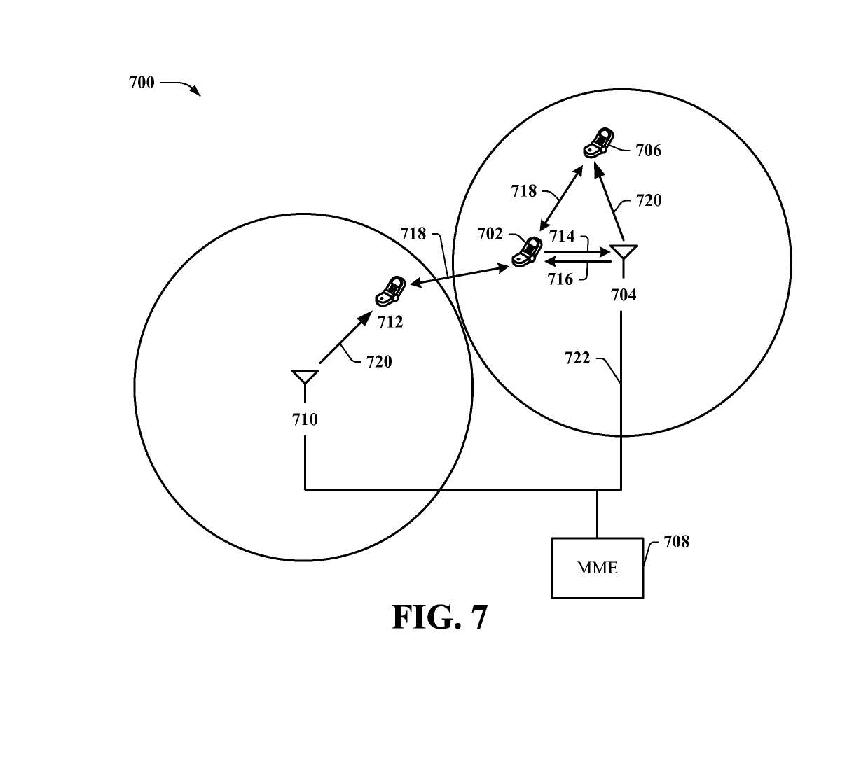

FIG. 7 is a drawing of an exemplary wireless wide area network (WWAN) communications system 700. The peer-to-peer communications system 700 includes a plurality of wireless devices (e.g., UEs) 702, 706, 712, and may include one or more base stations (e.g., eNB) 704, 710. In one aspect, base stations 704 and 723 may be connected over a network connection 733 though a network entity (e.g., MME 708). In an aspect, WWAN 700 may allow UEs (702, 706, 712) to engage in D2D communications in an environment in which eNodeB services may coexist. In such an aspect, the D2D communications may be supported using a protocol such as FlashLinQ, LTE Direct, etc., while the eNodeB services may be supported using a protocol such as LTE.

Wireless device 702 attempt to engage in device to device (D2D) communications 718 with one or more peer devices (e.g., 706, 712). To enable such D2D communications, a peer discovery procedure may be used to allow each of the devices to discover the presence of one or more other devices. each device may use a peer discovery resource during which it may broadcast an expression. Additionally, each peer device may monitor other devices peer discovery resources to detect any broadcast expressions. In the depicted aspect, each UE (e.g., 702, 706, 712) may be in communications with a base station (e.g., eNB 704, 710). In an aspect, multiple UEs (702, 706) may be supported by a single eNB 704. In another aspect, multiple UEs (702, 712) may be supported by multiples eNBs (704, 710) that may be in communication with each other through a MME 708.

A WAN entity (e.g., eNB 704, 710 and/or MME 708) may determine the peer discovery resource (e.g., time, frequency and power) used for each peer devices. Using a WAN based peer discovery resource assignment scheme allows the WWAN 700 to achieve efficient global peer discovery resource spacial reuse. In one aspect, the WAN entity may use the location of the peer devices in the network to determine which peer discovery resource to allocate to which device.

In an operational aspect, based on the physical locations of all peer devices in the WWAN 700, a WAN entity may determine the peer discovery resource for each peer device. In such an aspect, a UE 702 may report 714 its physical location to the base station 704. Additionally, the location information 714 may be shared amount base stations (704, 710) using a network connection 722. Thereafter, a WAN entity may determine peer resource allocations may provide such information to the UE in a control message 716. In another aspect in which a WAN entity may obtain coarse location information of peer devices (e.g., a cell identifier, etc.), depending on the cell size and a peer discovery radius, each cell may be assigned a subset of the whole time/frequency resource of peer discovery. As used herein, a discovery radius may reference to a distance from UE within the UE may discover another UE for D2D communications. Further, the WAN entity may allocate peer discovery resources 720 to one or more peer devices (706) in its cell and/or peer devices 712 in a neighboring cell through an MME 708. In an aspect, the assignment of the peer discovery resource to cell may be either static or dynamic.

In another operational aspect, each eNodeB (704, 710) may reserves one or more resources for peer discovery, such as described with reference to FIG. 5. In an aspect, such reserved resources may be uplink resources associated with the eNodeB (704, 710). In an aspect, resources can be divided between WWAN services and discovery resources, and such division may happen periodically (e.g., the resources reserved for discovery may occur periodically). In such an aspect, resource reserved for peer discovery may be indicated with peer discovery resource identifiers (PDRIDs). During peer discovery, a device (702) may transmit its discovery expression on its PDRID and try to decode the discovery expression on other PDRIDs (706, 712).

In such an operational aspect, the PDRIDs may be allocated to UEs (702, 706, 712) based at least in part on their locations. In such an aspect, a discovery resource “X” may be tied to a set of locations “L” and resource X may be used by a UE 702 when the UE 702 is in location L. Such resource linkage may reduce the amount of time a device may be awake to listen for discovery, and thereby reducing power consumption. In other words, considering a UE 702 that is at location M and with a defined discovery radius of “R.” In such an aspect, the UE 702 may listen to only those PDRIDs that are tied locations in a set of radius R around location M. Additionally, the UE 702 may conserve power by going to sleep on PDRIDs that are not coupled to location in a set of radius R around location M. Further, neighboring eNodeBs (704, 710) may divide resources using an offset. In such an aspect, resources that eNodeB 704 sets aside for discovery may be offset from the resources reserved for discovery by eNodeB 710. IN an aspect, the amount of offset may be a function of number of devices per cell, a discovery radius, cell size, etc.

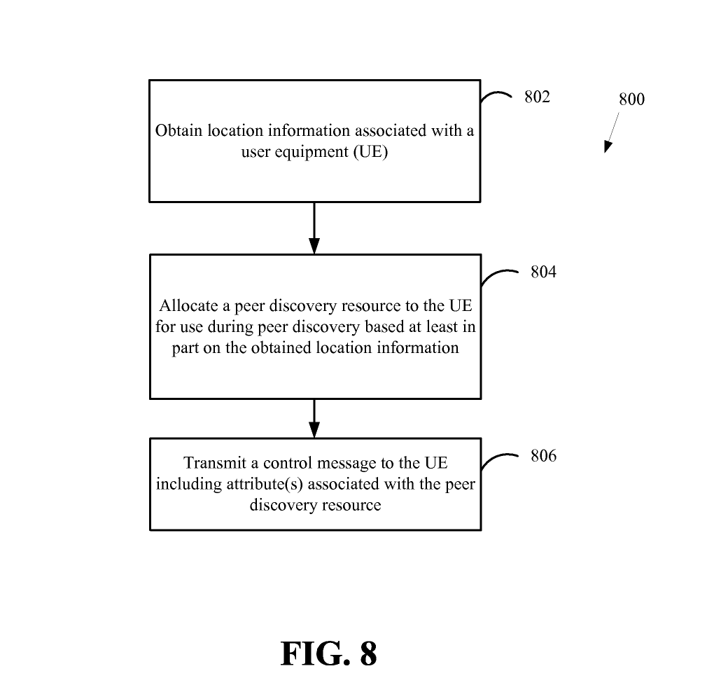

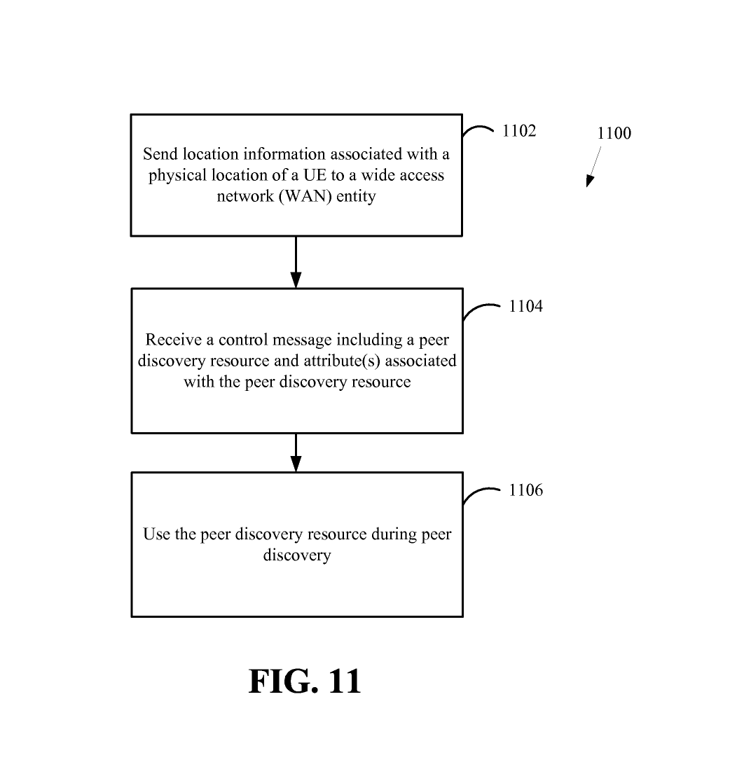

FIGS. 8 and 11 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 is a flow chart 800 of a method of wireless communication. The method may be performed by a WAN entity such as, but not limited to, an eNB, a MME, etc.

At block 802, the WAN entity may obtain location information associated with a UE. In an aspect, the WAN entity may receive the location information from the UE. In another aspect, the WAN entity may receive the location information from a neighboring WAN entity. In an aspect, the location information may information such as, but not limited to, a cell identity, etc.

At block 804, the WAN entity may allocate a peer discovery resource to the UE for use during peer discovery based at least in part on the obtained location information. In an aspect, the peer discovery resource may be further allocated based on values such as, but not limited to, a discovery radius in which the UE is operable to discover another UE for device to device (D2D) communications, a size of a cell, a number of UEs operating in the cell, etc. In an aspect, the peer discovery resource may be further allocated based on peer discovery resource allocation information received from a neighboring WAN entity.

Further, at block 806, the WAN entity may send a control message to the UE including the allocated peer discovery resource and one or more attributes associated with the peer discovery resource for use during peer discovery. In an aspect in which discovery resources are allocated to other UEs, the control message may also include information indicating these discovery resources. In such an aspect, the control message may further include information to prompt the UE to monitor for a discovery notification at the indicated discovery resources. In another aspect, the control message may further prompt the UE to not monitor when the indicated discovery resources are not present (e.g., only monitor at the indicated discovery resources). In another aspect, the attributes may include resource time information, resource frequency information, resource power information, etc.

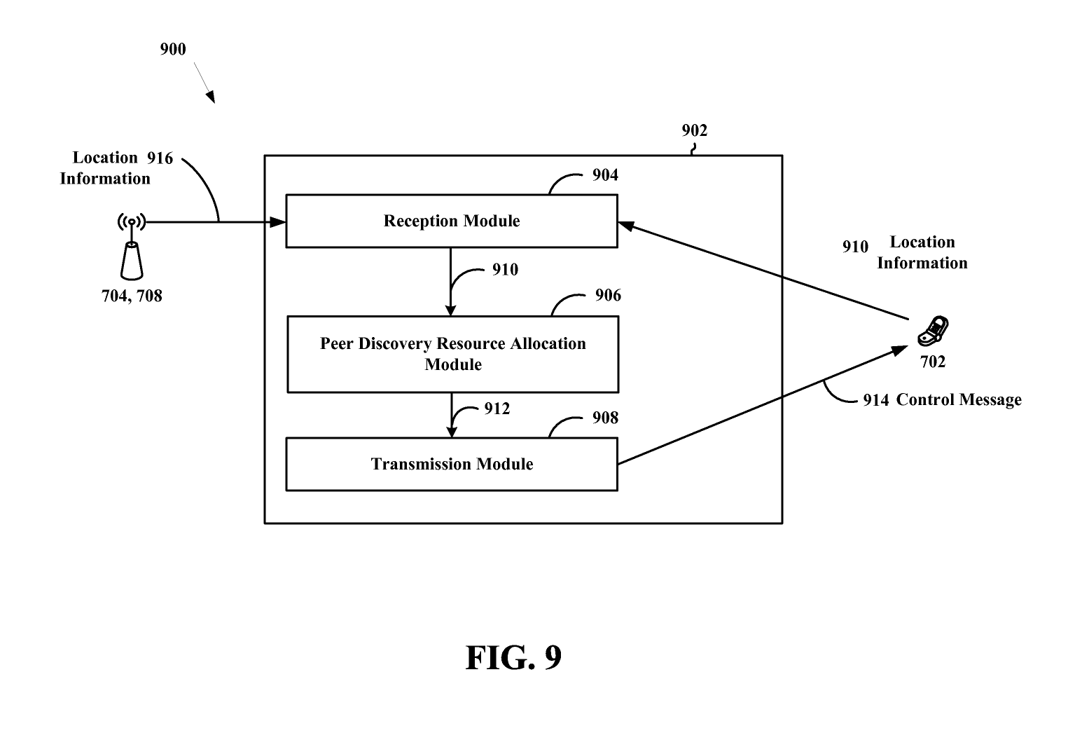

FIG. 9 is a conceptual data flow diagram 900 illustrating the data flow between different modules/means/components in an exemplary apparatus 902. The apparatus may be a WAN entity such as, but not limited to, an eNB, a MME, etc. The apparatus includes a reception module 904 that may receive location information 910 associated with a UE 702. In an aspect, the location information 910 may be received from a UE (such as UE 702). In another aspect, a neighboring WAN entity, such as eNB 708, may provide information such as, but not limited to, location information 916. The apparatus may further include a peer discovery resource allocation module 906 that may allocate a peer discovery resource 912 to the UE 702 for use during peer discovery based at least in part on the obtained location information (910, 916). In an aspect, the peer discovery resource 912 may be communicated to UE 702 in a control message 914. In an aspect in which discovery resources are allocated to other UEs, the control message 912 may also include information indicating these discovery resources. In such an aspect, the control message 914 may further include information to prompt the UE 702 to monitor for a discovery notification at the indicated discovery resources. In another aspect, the control message 914 may further prompt the UE 702 to not monitor when the indicated discovery resources are not present (e.g., only monitor at the indicated discovery resources). Additionally, the apparatus may include a transmission module 908 that may send the control message 914 to the UE 702 including the allocated peer discovery resource and one or more attributes associated with the peer discovery resource for use during peer discovery. In an aspect, the attributes may include resource time information, resource frequency information, resource power information, etc.

The apparatus may include additional modules that perform each of the steps of the algorithm in the aforementioned flow charts of FIG. 8. As such, each block in the aforementioned flow charts of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

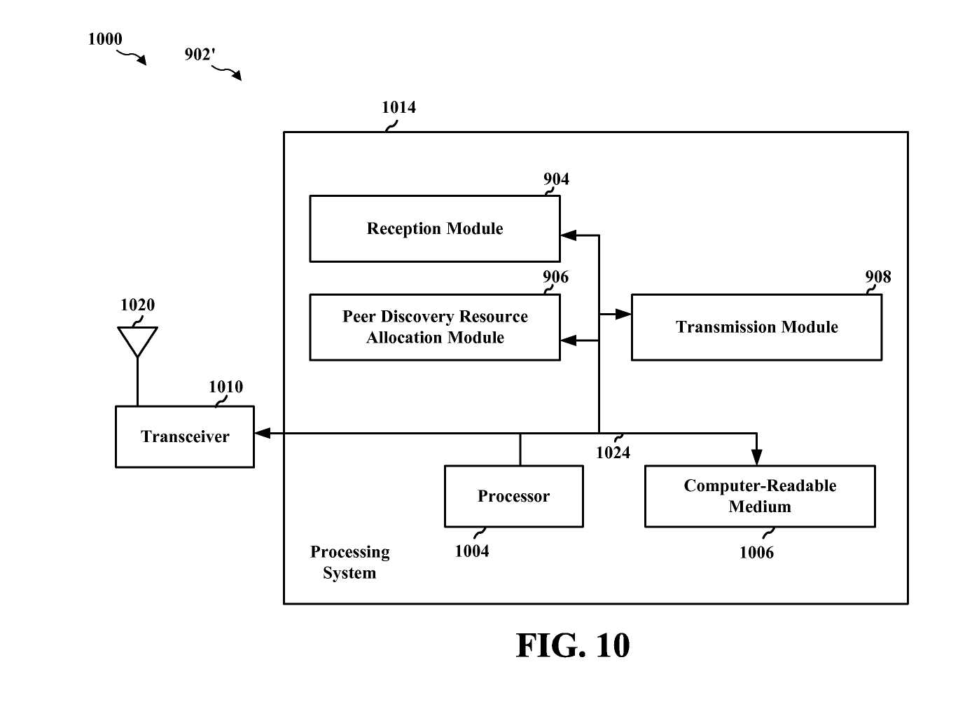

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1004, the modules 904, 906, 908, and the computer-readable medium 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The processing system 1014 includes a processor 1004 coupled to a computer-readable medium 1006. The processor 1004 is responsible for general processing, including the execution of software stored on the computer-readable medium 1006. The software, when executed by the processor 1004, causes the processing system 1014 to perform the various functions described supra for any particular apparatus. The computer-readable medium 1006 may also be used for storing data that is manipulated by the processor 1004 when executing software. The processing system further includes at least one of the modules 904, 906, and 908. The modules may be software modules running in the processor 1004, resident/stored in the computer readable medium 1006, one or more hardware modules coupled to the processor 1004, or some combination thereof. The processing system 1014 may be a component of the WAN entity (e.g., eNB, MME, etc.) 610 and may include the memory 676 and/or at least one of the TX processor 616, the RX processor 670, and the controller/processor 675.

In one configuration, the apparatus 902/902′ for wireless communication includes means for obtaining, by a WAN entity, location information associated with a UE, means for allocating a peer discovery resource to the UE for use during peer discovery based at least in part on the obtained location information, and means for sending a control message to the UE including the allocated peer discovery resource and one or more attributes associated with the peer discovery resource for use during peer discovery. In an aspect, the apparatus 902/902′ means for obtaining may further include means for receiving peer discovery resource allocation information from a neighboring WAN entity. In such an aspect, the peer discovery resource may be allocated further based at least in part on the received peer discovery resource allocation information. In an aspect, the apparatus 902/902′ means for obtaining may further include means for receiving location information from the UE.

The aforementioned means may be one or more of the aforementioned modules of the apparatus 902 and/or the processing system 1014 of the apparatus 902′ configured to perform the functions recited by the aforementioned means. As described supra, the processing system 1014 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

FIG. 11 is a flow chart 1100 of a method of wireless communication. The method may be performed by a UE.

At block 1102, the UE may send location information associated with a physical location of the UE to a WAN entity. In an aspect, the WAN entity may be an eNB, a MME, etc. In another aspect, the location information may include a cell identity.

At block 1104, the UE may receive a control message including a peer discovery resource and one or more attributes associated with the peer discovery resource. In an aspect, the peer discovery resource may be allocated by the WAN entity based at least in part on the location information. In another aspect, the control message may include information indicating the discovery resources allocated to other UEs. In such an aspect, the control message may also include information to prompt the UE to monitor for a discovery notification at the discovery resources allocated to the other UEs. In an aspect, the attributes may include resource time information, resource frequency information, resource power information, etc.

Further, at block 1106, the UE may use the peer discovery resource during peer discovery. In an aspect, the UE may broadcast an expression for peer devices to discover the UE during the allocated peer discovery resource. In another aspect in which the control message indicates peer discovery resources allocated to other UEs, the UE may monitor for transmissions at the allocated peer discovery resources.

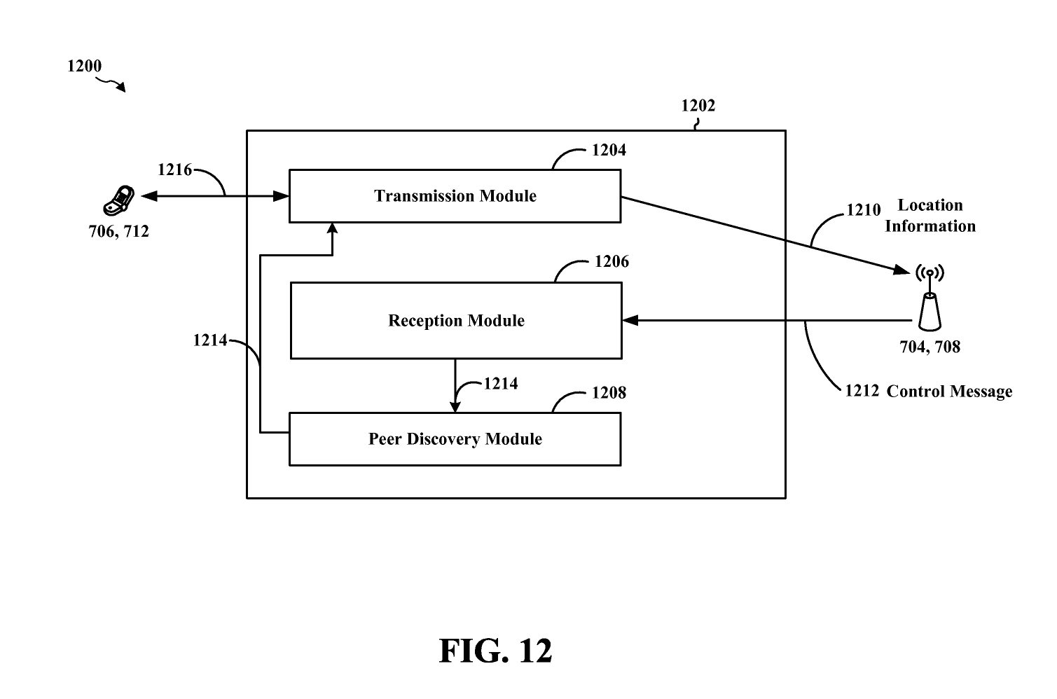

FIG. 12 is a conceptual data flow diagram 1200 illustrating the data flow between different modules/means/components in an exemplary apparatus 1202. The apparatus may be a UE. The apparatus includes a transmission module 1204 that sends location information 1210 associated with a physical location of the apparatus 1202 to a wide access network (WAN) entity (e.g., eNB 704 and/or MME 708). In an aspect, the WAN entity may be an eNB, a MME, etc. In another aspect, the location information may include a cell identity. Further, the apparatus may include a reception module 1206 that may receive a control message 1212 including a peer discovery resource 1214 and one or more attributes associated with the peer discovery resource 1214. In an aspect, the peer discovery resource 1214 may be allocated by the WAN entity (704, 708) based at least in part on the location information. In another aspect, the control message 1212 may include information indicating the discovery resources allocated to other UEs (e.g., 706, 712). In such an aspect, the control message 1212 may also include information to prompt the apparatus 1202 to monitor for a discovery notification at the discovery resources allocated to the other UEs (e.g., 706, 712). In an aspect, the attributes may include resource time information, resource frequency information, resource power information, etc. Additionally, the apparatus may include a peer discovery module 1208 that may be used to assist in performing peer discovery 1216. In an aspect, as part of a peer discovery 1216 process, the apparatus 1202 may broadcast an expression for peer devices (e.g., 706, 712) to discover during the allocated peer discovery resource 1214. In another aspect, as part of a peer discovery process 1216, in which the control message 1212 indicates peer discovery resources allocated to other UEs (e.g., 706, 712), the apparatus 1202 may monitor for transmissions at the allocated peer discovery resources.

The apparatus may include additional modules that perform each of the steps of the algorithm in the aforementioned flow charts of FIG. 11. As such, each step in the aforementioned flow charts of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

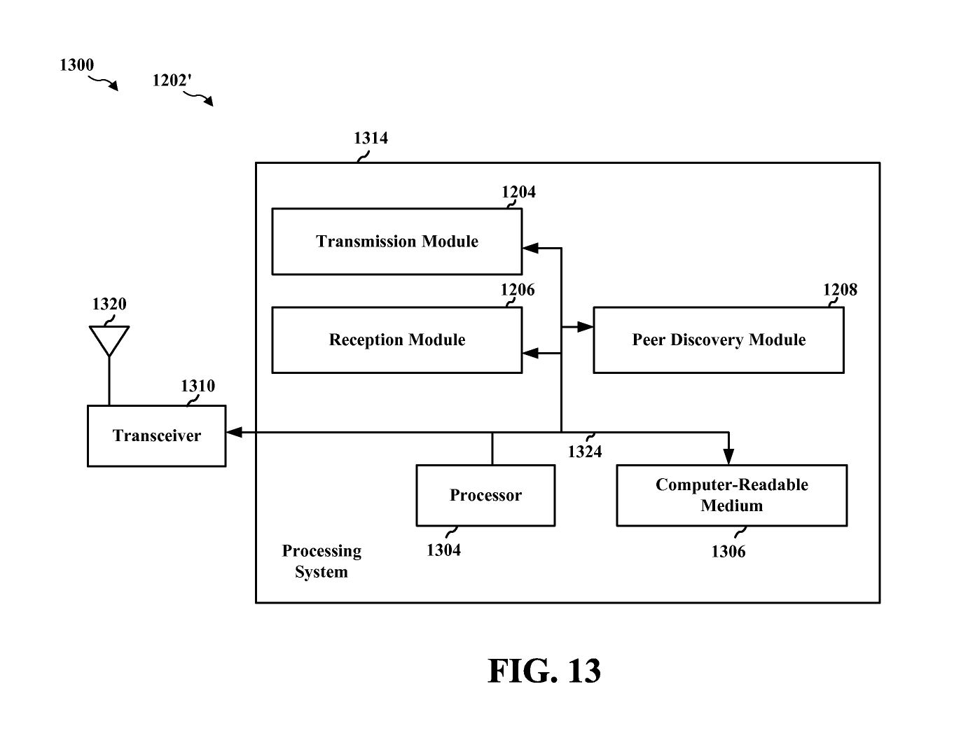

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, and 1208. The modules may be software modules running in the processor 1304, resident/stored in the computer readable medium _1306, one or more hardware modules coupled to the processor 1304, or some combination thereof. The processing system 1314 may be a component of the UE 650 and may include the memory 660 and/or at least one of the TX processor 668, the RX processor 656, and the controller/processor 659.

In one configuration, the apparatus 1202/1202′ for wireless communication includes means for sending location information associated with a physical location of a UE to a WAN entity, means for receive a control message including a peer discovery resource and one or more attributes associated with the peer discovery resource, and means for using the peer discovery resource during peer discovery. In an aspect, the peer discovery resource may be allocated by the WAN entity based at least in part on the location information. In an aspect, the apparatus 1202/1202′ means for using may further include means for monitoring other discovery resources allocated to other UEs during peer discovery. The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communications, comprising:
obtaining, by a wide area network (WAN) entity, location information associated with a user equipment (UE);
allocating a peer discovery resource to the UE for use during peer discovery based at least in part on the obtained location information; and
sending a control message to the UE including the allocated peer discovery resource and one or more attributes associated with the peer discovery resource for use during peer discovery.

2. The method of claim 1, wherein the one or more other discovery resources are allocated to one or more other UEs, and wherein the control message further includes information indicating the one or more other allocated discovery resources.

3. The method of claim 2, wherein the control message further includes information to prompt the UE to monitor for a discovery notification at the one or more other allocated discovery resources.

4. The method of claim 1, wherein the WAN entity comprises at least one of an evolved NodeB (eNodeB), or a mobile management entity (MME).

5. The method of claim 1, wherein the peer discovery resource is allocated further based on at least one of:
a discovery radius in which the UE is operable to discover another UE for device to device (D2D) communications, a size of a cell, or a number of UEs operating in the cell.

6. The method of claim 1, wherein the obtaining further comprises receiving peer discovery resource allocation information from a neighboring WAN entity; and
wherein the peer discovery resource is allocated further based at least in part on the received peer discovery resource allocation information.

7. The method of claim 1, wherein obtaining the location information comprises receiving location information from the UE.

8. The method of claim 1, wherein the location information comprises a cell identity associated with the UE.

9. The method of claim 1, wherein the one or more attributes include at least one of: resource time information, resource frequency information, or resource power information.

10. A method of wireless communications, comprising:
sending, by a user equipment (UE), location information associated with a physical location of the UE to a wide access network (WAN) entity;
receiving a control message including a peer discovery resource and one or more attributes associated with the peer discovery resource, wherein the peer discovery resource is allocated by the WAN entity based at least in part on the location information; and
using the peer discovery resource during peer discovery.

11. The method of claim 10, wherein the control message further includes information indicating the one or more discovery resources allocated to one or more other UEs.

12. The method of claim 11, wherein the control message further includes information to prompt the UE to monitor for a discovery notification at the one or more other allocated discovery resources; and wherein the using further comprises:
monitoring the one or more other allocated discovery resources during peer discovery.

13. The method of claim 10, wherein the one or more attributes include at least one of: resource time information, resource frequency information, resource power information, or any combination thereof.

14. The method of claim 10, wherein the location information comprises a cell identity associated with the UE.

15. The method of claim 10, wherein the WAN entity is a mobile management entity (MME), and wherein the location information is transmitted by the UE to a serving evolved NodeB (eNB) to be sent to the MME.

16. An apparatus for communications, comprising:
means for obtaining, by a wide area network (WAN) entity, location information associated with a user equipment (UE);
means for allocating a peer discovery resource to the UE for use during peer discovery based at least in part on the obtained location information; and
means for sending a control message to the UE including the allocated peer discovery resource and one or more attributes associated with the peer discovery resource for use during peer discovery.

17. The apparatus of claim 16, wherein the one or more other discovery resources are allocated to one or more other UEs, and wherein the control message further includes information indicating the one or more other allocated discovery resources.

18. The apparatus of claim 17, wherein the control message further includes information to prompt the UE to monitor for a discovery notification at the one or more other allocated discovery resources.

19. The apparatus of claim 16, wherein the WAN entity comprises at least one of an evolved NodeB (eNodeB), or a mobile management entity (MME).

20. The apparatus of claim 16, wherein the peer discovery resource is allocated further based on at least one of:
a discovery radius in which the UE is operable to discover another UE for device to device (D2D) communications, a size of a cell, or a number of UEs operating in the cell.

21. The apparatus of claim 16, wherein the means for obtaining is further configured to receive peer discovery resource allocation information from a neighboring WAN entity; and
wherein the peer discovery resource is allocated further based at least in part on the received peer discovery resource allocation information.

22. The apparatus of claim 16, wherein means for obtaining the location information is further configured to receive location information from the UE.

23. The apparatus of claim 16, wherein the location information comprises a cell identity associated with the UE.

24. The apparatus of claim 16, wherein the one or more attributes include at least one of: resource time information, resource frequency information, or resource power information.

25. An apparatus for wireless communications, comprising:
means for sending, by a user equipment (UE), location information associated with a physical location of the UE to a wide access network (WAN) entity;
means for receiving a control message including a peer discovery resource and one or more attributes associated with the peer discovery resource, wherein the peer discovery resource is allocated by the WAN entity based at least in part on the location information; and
means for using the peer discovery resource during peer discovery.

26. The apparatus of claim 25, wherein the control message further includes information indicating the one or more discovery resources allocated to one or more other UEs.

27. The apparatus of claim 26, wherein the control message further includes information to prompt the UE to monitor for a discovery notification at the one or more other allocated discovery resources, and wherein the one or more other allocated discovery resources are used during the peer discovery.

28. The apparatus of claim 25, wherein the one or more attributes include at least one of: resource time information, resource frequency information, resource power information, or any combination thereof.

29. The apparatus of claim 25, wherein the location information comprises a cell identity associated with the UE.

30. The apparatus of claim 25, wherein the WAN entity is a mobile management entity (MME), and wherein the location information is transmitted by the UE to a serving evolved NodeB (eNB) to be sent to the MME.

31. A computer program product, comprising:
a computer-readable medium comprising code for:
obtaining, by a wide area network (WAN) entity, location information associated with a user equipment (UE);
allocating a peer discovery resource to the UE for use during peer discovery based at least in part on the obtained location information; and
sending a control message to the UE including the allocated peer discovery resource and one or more attributes associated with the peer discovery resource for use during peer discovery.

32. The computer program product of claim 31, wherein the one or more other discovery resources are allocated to one or more other UEs, and wherein the control message further includes information indicating the one or more other allocated discovery resources.

33. The computer program product of claim 32, wherein the control message further includes information to prompt the UE to monitor for a discovery notification at the one or more other allocated discovery resources.

34. The computer program product of claim 31, wherein the WAN entity comprises at least one of an evolved NodeB (eNodeB), or a mobile management entity (MME).

35. The computer program product of claim 31, wherein the peer discovery resource is allocated further based on at least one of:
a discovery radius in which the UE is operable to discover another UE for device to device (D2D) communications, a size of a cell, or a number of UEs operating in the cell.

36. The computer program product of claim 31, wherein the computer-readable medium further comprises code for receiving peer discovery resource allocation information from a neighboring WAN entity; and
wherein the peer discovery resource is allocated further based at least in part on the received peer discovery resource allocation information.

37. The computer program product of claim 31, wherein computer-readable medium further comprises code for receiving location information from the UE.

38. The computer program product of claim 31, wherein the location information comprises a cell identity associated with the UE.

39. The computer program product of claim 31, wherein the one or more attributes include at least one of: resource time information, resource frequency information, or resource power information.

40. A computer program product, comprising:
a computer-readable medium comprising code for:
sending, by a user equipment (UE), location information associated with a physical location of the UE to a wide access network (WAN) entity;
receiving a control message including a peer discovery resource and one or more attributes associated with the peer discovery resource, wherein the peer discovery resource is allocated by the WAN entity based at least in part on the location information; and
using the peer discovery resource during peer discovery.

41. The computer program product of claim 40, wherein the control message further includes information indicating the one or more discovery resources allocated to one or more other UEs.

42. The computer program product of claim 41, wherein the control message further includes information to prompt the UE to monitor for a discovery notification at the one or more other allocated discovery resources; and wherein the computer-readable medium further comprises code for:
monitoring the one or more other allocated discovery resources during the peer discovery.

43. The computer program product of claim 40, wherein the one or more attributes include at least one of: resource time information, resource frequency information, resource power information, or any combination thereof.

44. The computer program product of claim 40, wherein the location information comprises a cell identity associated with the UE.

45. The computer program product of claim 40, wherein the WAN entity is a mobile management entity (MME), and wherein the location information is transmitted by the UE to a serving evolved NodeB (eNB) to be sent to the MME.

46. An apparatus for communication, comprising:
a processing system configured to:
obtain, by a wide area network (WAN) entity, location information associated with a user equipment (UE);
allocate a peer discovery resource to the UE for use during peer discovery based at least in part on the obtained location information; and
send a control message to the UE including the allocated peer discovery resource and one or more attributes associated with the peer discovery resource for use during peer discovery.

47. The apparatus of claim 46, wherein the one or more other discovery resources are allocated to one or more other UEs, and wherein the control message further includes information indicating the one or more other allocated discovery resources.

48. The apparatus of claim 47, wherein the control message further includes information to prompt the UE to monitor for a discovery notification at the one or more other allocated discovery resources.

49. The apparatus of claim 46, wherein the WAN entity comprises at least one of an evolved NodeB (eNodeB), or a mobile management entity (MME).

50. The apparatus of claim 46, wherein the peer discovery resource is allocated further based on at least one of:
a discovery radius in which the UE is operable to discover another UE for device to device (D2D) communications, a size of a cell, or a number of UEs operating in the cell.

51. The apparatus of claim 46, wherein the processing system is further configured to receive peer discovery resource allocation information from a neighboring WAN entity; and
wherein the peer discovery resource is allocated further based at least in part on the received peer discovery resource allocation information.

52. The apparatus of claim 46, wherein the processing system is further configured to receive location information from the UE.

53. The apparatus of claim 46, wherein the location information comprises a cell identity associated with the UE.

54. The apparatus of claim 46, wherein the one or more attributes include at least one of: resource time information, resource frequency information, or resource power information.

55. An apparatus for wireless communications, comprising:
a processing system configured to:
send, by a user equipment (UE), location information associated with a physical location of the UE to a wide access network (WAN) entity;
receive a control message including a peer discovery resource and one or more attributes associated with the peer discovery resource, wherein the peer discovery resource is allocated by the WAN entity based at least in part on the location information; and
use the peer discovery resource during peer discovery.

56. The apparatus of claim 55, wherein the control message further includes information indicating the one or more discovery resources allocated to one or more other UEs.

57. The apparatus of claim 56, wherein the control message further includes information to prompt the UE to monitor for a discovery notification at the one or more other allocated discovery resources; and wherein the processing system is further configured to:
monitor the one or more other allocated discovery resources during the peer discovery.

58. The apparatus of claim 55, wherein the one or more attributes include at least one of: resource time information, resource frequency information, resource power information, or any combination thereof.

59. The apparatus of claim 55, wherein the location information comprises a cell identity associated with the UE.

60. The apparatus of claim 55, wherein the WAN entity is a mobile management entity (MME), and wherein the location information is transmitted by the UE to a serving evolved NodeB (eNB) to be sent to the MME.
